(19) United States
(12) Patent Application Publication
(10) Pub. No.: US 2012/0204745 A1
(43) Pub. Date: Aug. 16, 2012

(54) ROLL IMPRINTING APPARATUS

(75) Inventors: Jeong-Dai Jo, Daejeon (KR); Jong-Su Yu, Daejeon (KR); Seong-Man Yoon, Daejeon (KR); Dong-Soo Kim, Daejeon (KR); Kwang-Young Kim, Daejeon (KR)

(73) Assignee: Korea Institute of Machinery & Materials, Daejeon (KR)

(21) Appl. No.: 13/499,837

(22) PCT Filed: Sep. 29, 2010
(86) PCT No.: PCT/KR2010/006609

§ 371 Date: Apr. 2, 2012

(30) Foreign Application Priority Data
Oct. 28, 2009 (KR) 10-2009-0102910

(51) Int. Cl. B41F 5/18

(52) U.S. Cl. 101/216

(57) ABSTRACT

An exemplary embodiment of the present invention relates to roll imprint that simplifies a substrate patterning process by simultaneously performing a process for imprinting a pattern to a coating layer and a process for curing the pattern.

A roll imprinting apparatus according to an exemplary embodiment of the present invention performs an imprinting process on a transferred substrate. The roll imprinting apparatus includes: a pattern roll imprinting a pattern formed in the surface thereof to the substrate while rotating; and a press roll pressing the substrate while rotating in the opposite side of the pattern roll, interposing the substrate therebetween, and the pattern roll includes a cylinder and a UV lamp. The cylinder is formed of a transparent material and has an inner space formed thereinside and the pattern provided in the external surface thereof, and has a ultraviolet (UV) ray block layer selectively formed in the patterned portion or a portion

### TECHNICAL FIELD

The present invention relates to a roll imprinting apparatus. More particularly, the present invention relates to a roll imprinting apparatus that imprints a pattern to a coating layer of a substrate and at the same time cures the pattern.

### Background Art

Imprint lithography is a method that directly transfers a mold pattern using a press, and a complicated step can be formed relatively simple to an object substrate through the imprint lithography. In particular, the mold pattern is directly patterned to the substrate so that the process can be finished with one press transfer compared to a conventional method requiring several photolithography processes.

The recent trend is a roll-to-roll sequential process for pattern to a film substrate and mass production. Here, a pattern roll and a press roll make a film substrate pass between the press roll and the pattern roll to imprint a pattern to a coating layer of the film substrate. The patterned film substrate is moved to the next process for curing the coating process.

The pattern imprinting process and the pattern curing process are separately performed, and accordingly, the patterning process of the film substrate becomes complicated.

### DISCLOSURE

### Technical Problem

The present invention has been made in an effort to provide roll imprint that can simplify a substrate patterning process by simultaneously performing a process for imprinting a pattern to a coating layer and a process for curing the pattern.

### Technical Solution

A roll imprinting apparatus according to an exemplary embodiment of the present invention performs an imprinting process on a transferred substrate. The roll imprinting apparatus includes: a pattern roll imprinting a pattern formed in the surface thereof to the substrate while rotating; and a press roll pressing the substrate while rotating in the opposite side of the pattern roll, interposing the substrate therebetween, and the pattern roll includes a cylinder and a UV lamp. The cylinder is formed of a transparent material and has an inner space formed thereinside and the pattern provided in the external surface thereof, and has a ultraviolet (UV) ray block layer selectively formed in the patterned portion or a portion between the patterns.

The UV ray block layer may be formed of a metal material layer blocking UV rays. The metal material layer may include at least one of Cr, Al, and Ti.

The pattern roll may further include a pair of first and second flanges attached to both ends of the cylinder to support the cylinder and first and second rotational shafts respectively, integrally formed to the first and second flanges.

The UV lamp may be disposed along a length direction of the cylinder in the space of the cylinder, and both ends of the UV lamp may be respectively mounted to the first and second flanges.

The substrate may include a base and a coating layer formed of an UV curing material on the base.

The UV curing material may be formed of one of a photoresist, a resin, and ink.

The cylinder may be formed of quartz, glass, or transparent plastic.

The pattern of the cylinder may be formed through electron beam lithography, photo lithography, and laser irradiation.

### Advantageous Effects

As described, according to the exemplary embodiment of the present invention, the cylinder of the pattern roll is formed of a transparent material, the UV ray block layer is provided according to a pattern, and the UV lamp is provided in the cylinder so that the pattern can be cured while simultaneously being imprinted by the pattern roll. Accordingly, the patterning process of the substrate can be simplified.

### DESCRIPTION OF DRAWINGS

FIG. 1 is a schematic diagram of a roll imprinting apparatus according to an exemplary embodiment of the present invention.

FIG. 2 is a perspective view of a pattern roll applied to the roll imprinting apparatus according to the exemplary embodiment of the present invention.

FIG. 3 is an exploded perspective view of the pattern roll of FIG. 2.

FIG. 4 is a cross-sectional view of the pattern roll of FIG. 2.

FIG. 5 is a manufacturing process view of the pattern roll applied to the roll imprinting apparatus according to the exemplary embodiment of the present invention.

FIG. 6 is a side view of a substrate imprinted by irradiation of ultraviolet rays by the roll imprinting apparatus according to the exemplary embodiment of the present invention.

FIG. 7 is a process diagram of imprinting and curing of the substrate of FIG. 6.

FIG. 8 is a photo of a product imprinted and cured by the roll imprinting apparatus according to the exemplary embodiment of the present invention.

FIG. 9 is a side view of a substrate imprinted by a roll imprinting apparatus according to another exemplary embodiment of the present invention.

<Description of Reference Numerals Indicating
Primary Elements in the Drawings>

| | |
|---|---|
| 10: roll imprinting apparatus | 12: film roll |
| 14: press roll | 15, 16: electrostatic shielding device |
| 17: stepping motor | 18: pre-heater |
| 19: load cell | 20, 220: pattern roll |
| 21, 221: cylinder | 22: UV lamp |

23, 24: first and second flange
25, 26: first and second rotational shaft

| | |
|---|---|
| 32: cooler | 34: cutter |
| 41, 241: base | 42, 242: coating layer |
| P: pattern | S: substrate |
| ML: metal material layer | |

### MODE FOR INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

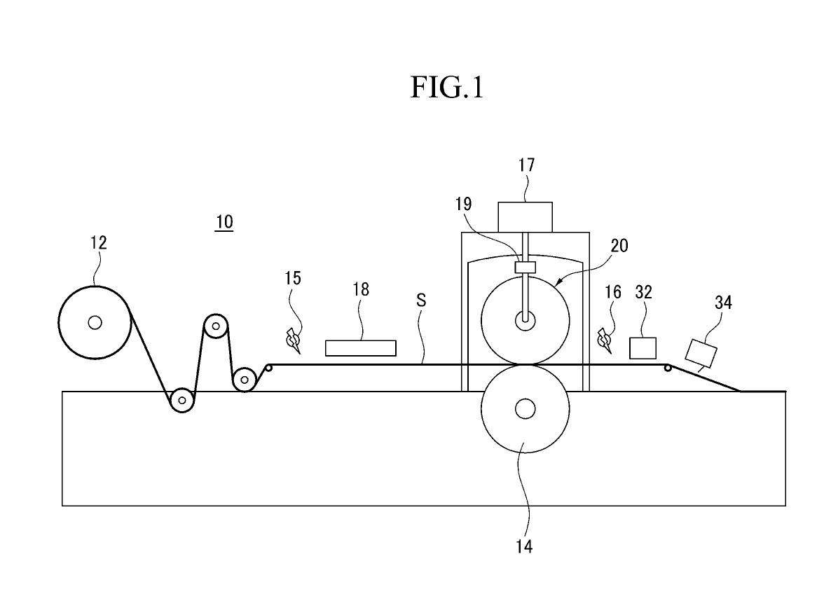

FIG. 1 is a schematic diagram of a roll imprinting apparatus according to an exemplary embodiment of the present invention. Referring to FIG. 1, a roll imprinting apparatus 10 includes a film roll 12, a pattern roll 20, and a press roll 14. The film roll 12 supplies a film while rotating a film substrate S wound in the shape of a roll, and the pattern roll 20 imprints a pattern formed in the surface thereof to the film substrate S while rotating. The press roll 14 rotates while being adjacent to the pattern roll 20 such that the film substrate S is pressed while being passed between the pattern roll 20 and the press roll 14. The press roll 14 may be selected from soft press rolls formed of rigid press roll, formed of metal, and polymer depending on its purpose of use.

The pattern roll 20 is connected to a stepping motor 17, interposing a load cell 19 therebetween. The stepping motor 17 is controlled according to a load of the load cell 19 such that a pressure of the pattern roll 20 with respect to the film substrate S can be controlled. Thus, the roll imprinting apparatus 10 finely controls the pressure of the pattern roll 20 so that the pattern can be imprinted to the film substrate S with various scales of 100 nm to 100 μm.

In a path of the film substrate S, electrostatic shielding devices 15 and 16 are provided front and rear sides of the pattern roll 20. The electrostatic shielding devices 15 and 16 prevent contamination of the film substrate S due to dust and the like, and they are provided in an input end and an output end of the pattern roll 20 of the film substrate S with reference to the pattern roll 20.

A preheater 18 is provided in the input tend of the pattern roll 20, and a cooler 32 and a cutter 34 are provide in the output end of the pattern roll 20. The preheater 18 simplifies imprinting of the pattern by heating the film substrate S. The cooler 32 minimizes deformation of the pattern shape by cooling the heated film substrate S. The cutter 34 cuts sequentially continuous film substrate S into a proper size at a rear side of the cooler 32.

The film substrate S is an example of a substrate imprinting a pattern formed in the pattern roll 20. That is, the substrate includes a film substrate, a wafer, or a glass substrate. Thus, hereinafter, it will be referred to as a substrate S.

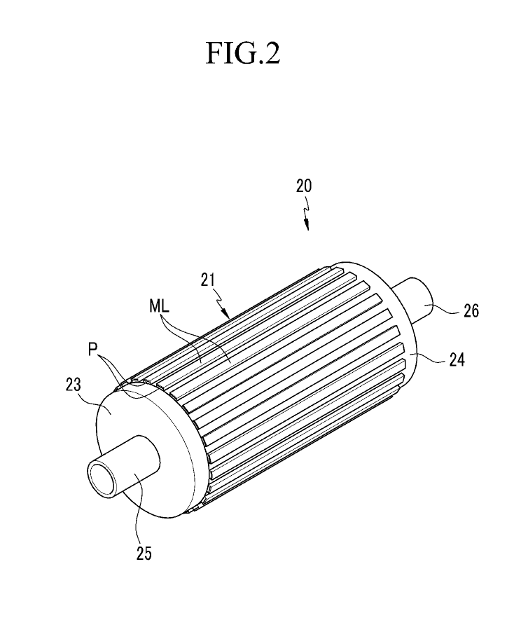

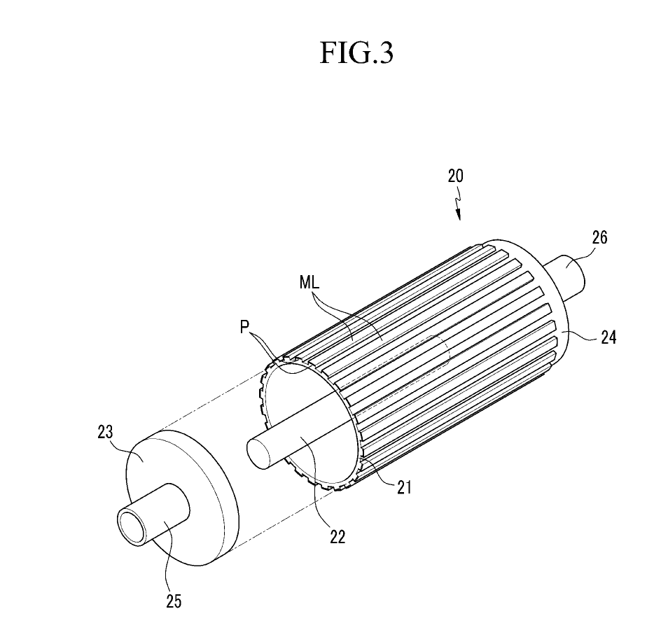

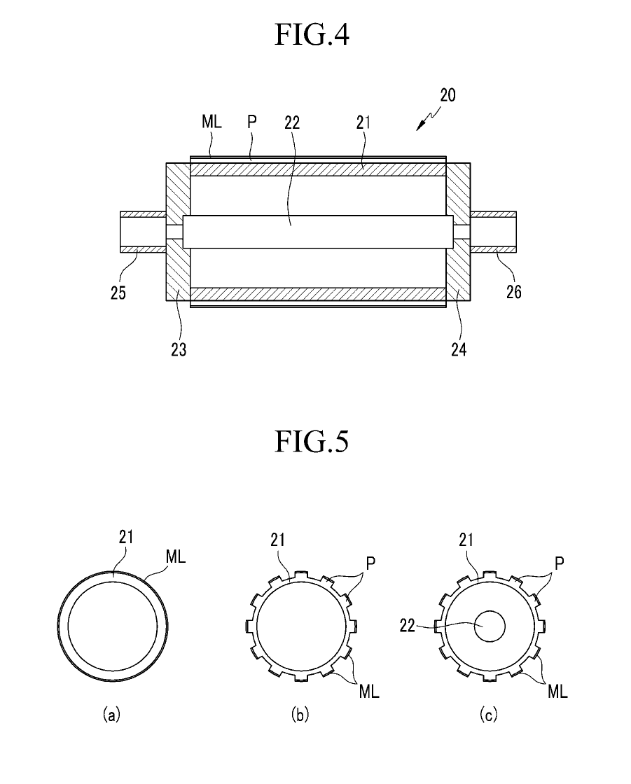

FIG. 2 is a perspective view of the pattern roll applied to the roll imprinting apparatus according to the exemplary embodiment of the present invention, FIG. 3 is an exploded perspective view of the pattern roll of FIG. 2, and FIG. 4 is a cross-sectional view of the pattern roll of FIG. 2.

Referring to FIG. 2 to FIG. 4, the pattern roll 20 includes a cylinder 21 having an inner space and formed of a transparent material and a UV lamp 22 provided in the inner space of the cylinder 21 and irradiating ultraviolet (UV) rays. The cylinder 21 has a pattern P in the external surface thereof.

Further, the cylinder 21 is provided with a metal material layer ML including Cr, Al, or Ti in the pattern P to block the ultraviolet rays and the UV rays are transmitted through the patterns P such that imprinting and curing can be simultaneously performed. Here, Cr, Al, or Ti is an example of the metal material layer ML, and the metal material layer ML is an example of a UV block layer.

The cylinder 21 is formed of a transparent material to prevent irradiation of the UV rays from be blocked in portions between patterns P, and for example, the cylinder 21 may be formed of quartz, glass, or transparent plastic. Thus, the UV rays irradiated from the UV lamp 22 can be irradiated to the substrate S through the portions between the patterns P of the cylinder 21.

For example, the pattern roll 20 further includes first and second flanges 23 and 24 and first and second rotational shafts 25 and 26 for rotatable driving of the pattern roll 20 and mounting of the UV lamp 22. The first and second flanges 23 and 24 are respectively attached to both ends of the cylinder 21 to support the cylinder 21. The first and second flanges 23 and 24 may be rigidly fastened to each other by a fastening member (not shown) penetrating through the cylinder 21. The first and second rotational shafts 25 and 26 are integrally connected to the first and second flanges 23 and 24, respectively to rotate the pattern roll 20.

The UV lamp 22 is disposed along a length direction of the cylinder 21 in the inner space of the cylinder 21 such that both ends of the UV lamp 22 are mounted on the first and second flanges 23 and 24. That is, the UV lamp 22 is mounted on the first and second flanges 23 and 24 from the inner sides of the first and second rotational shafts 25 and 26. When the first and second rotational shafts 25 and 26 are formed as hollow space shafts, the UV lamp 22 may be connected to a power source (not shown) through the first and second rotational shafts 25 and 26.

The pattern P of the cylinder 21 may be formed by electron beam lithography, photo lithography, or laser irradiation.

FIG. 5 is a manufacturing process diagram of the pattern roll applied to the roll imprinting apparatus according to the exemplary embodiment of the present invention. Referring to FIG. 5, a manufacturing process of the pattern roll 20 includes a manufacturing process of the cylinder 21 and a mounting process of the UV lamp 22. That is, the cylinder manufacturing process includes (a) preparing the cylinder 21 formed of a transparent material, forming the pattern P in the external surface of the cylinder 21, and (b) forming the metal material layer ML in the pattern P. The metal material layer ML is formed in the external surface of the cylinder 21, and the metal material layer ML and the pattern P may be formed together. The mounting process of the UV lamp 22 includes mounting the UV lamp 22 in the inner space of the cylinder 21 such that pattern roll 20 is completed.

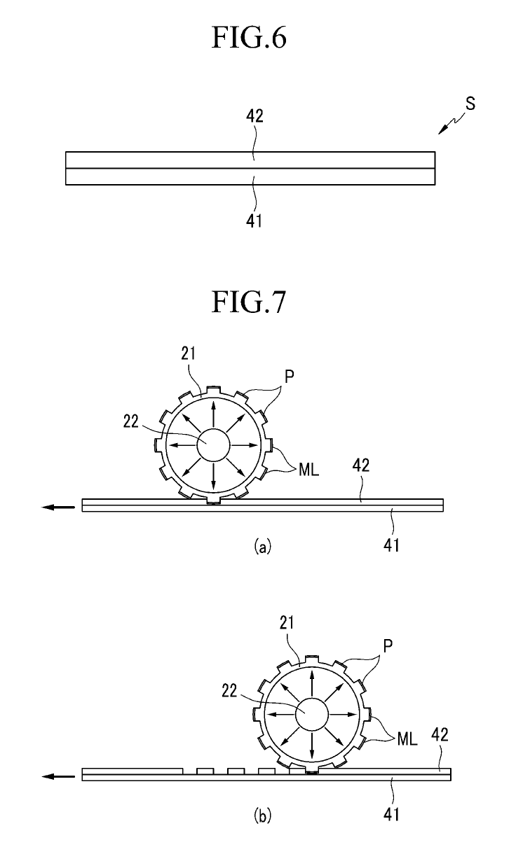

As shown in FIG. 5, the manufactured pattern roll 20 imprints the pattern P in the substrate S shown in FIG. 6, and at the same time, UV rays are irradiated between the patterns P, that is, metal material layers ML to cure the imprinted substrate S.

FIG. 6 is a side view of the substrate imprinted by irradiation of the UV rays by the roll imprinting apparatus according to the exemplary embodiment of the present invention. Referring to FIG. 6, the substrate S includes a base 41 and a coating layer 42 formed of a UV curing material on the base 41. That is, the UV curing material may be formed of a photoresist, a resin, or ink The resin may be polymethyl methacrylate (PMMA).

FIG. 7 is a process diagram of imprinting and curing of the substrate of FIG. 6. Referring to FIG. 7, when the pattern roll 20 is rotated and the substrate S is transferred (from left to right in FIG. 7), the pattern P of the pattern roll 20 presses the substrate S such that the pattern P is imprinted to the coating layer 42. Simultaneously, the UV lamp 22 is driven and thus the UV rays are irradiated to the outside through the portions between the patterns P of the cylinder 21, that is, between the metal material layer ML. Thus, the coating layer 42 imprinted by irradiation of the UV rays between the patterns P or the metal material layers ML and then cured. That is, the imprinting of the pattern P of the substrate S and the curing of the coating layer 42 are simultaneously performed so that a process time can be shortened.

After the imprinting of the pattern P and curing of the coating layer 42, the substrate S performs a post process such as developing, etching, deposition, printing, and coating as necessary.

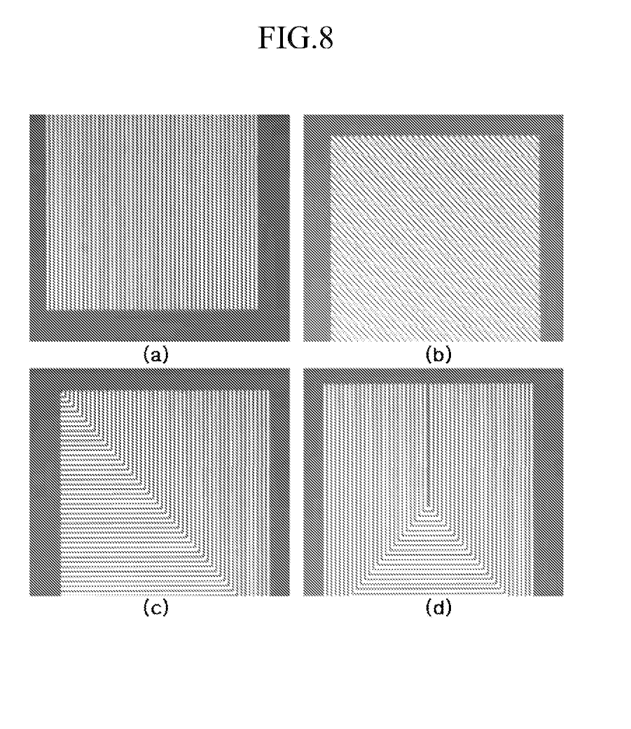

FIG. 8 is a photo of a product imprinted and cured by the roll imprinting apparatus according to the exemplary embodiment of the present invention. FIG. 8 exemplarily shows intermediate products, that is, wafers of which various patterns such as a straight line pattern (a), an oblique line (b), a pattern having a right angle (c), and a pattern having two right angles are imprinted and cured by applying the pattern roll 20 of the present exemplary embodiment.

In addition, a solar cell, a reflection film, LPG, a shielding film, or a prism sheet may be manufactured by applying the pattern roll 20 of the exemplary embodiment to the substrate S.

In a first exemplary embodiment, a pattern roll 20 is provided with a metal material layer ML in a portion of a pattern P to block UV rays with the metal material layer ML. However, in a second exemplary embodiment, a pattern roll 20 is provided with a metal material layer ML in a portion between patterns P to block UV rays with the metal material layer ML. That is, an embossed portion in the imprinted pattern is cured according to the first exemplary embodiment, and an engraved portion in the imprinted pattern is cured according to the second exemplary embodiment.

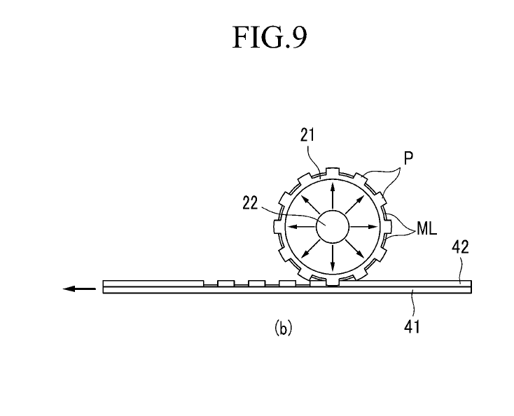

FIG. 9 is a side view of a substrate imprinted by a roll imprinting apparatus according to another exemplary embodiment of the present invention. Referring to FIG. 9, a cylinder 221 is provided with a metal material layer ML in a portion between patterns P. Thus, during an imprinting process, the metal material layer ML formed in the portion between patterns P blocks UV rays and portions of the pattern P transmit UV rays to the outside of the cylinder 221 such that the imprinting of the pattern P to the substrate S and curing of a coating layer 242 on a base 241 can be simultaneously performed. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A roll imprinting apparatus performing an imprinting process on a transferred substrate, comprising:
a pattern roll imprinting a pattern formed in the surface thereof to the substrate while rotating; and
a press roll pressing the substrate while rotating in the opposite side of the pattern roll, interposing the substrate therebetween,
wherein the pattern roll comprises,
a cylinder having an inner space, formed of a transparent material and having the pattern provided in the external surface thereof, and having a ultraviolet (UV) ray block layer selectively formed in the patterned portion or a portion between the patterns, and
a UV lamp provided in the space of the cylinder to irradiate the UV ray.

2. The roll imprinting apparatus of claim 1, wherein the UV ray block layer is formed of a metal material layer blocking UV rays.

3. The roll imprinting apparatus of claim 2, wherein the metal material layer comprises at least one of Cr, Al, and Ti.

4. The roll imprinting apparatus of claim 1, wherein the pattern roll further comprises,
a pair of first and second flanges attached to both ends of the cylinder to support the cylinder, and
first and second rotational shafts respectively, integrally formed to the first and second flanges.

5. The roll imprinting apparatus of claim 4, wherein the UV lamp is disposed along a length direction of the cylinder in the space of the cylinder, and both ends of the UV lamp are respectively mounted to the first and second flanges.

6. The roll imprinting apparatus of claim 1, wherein the substrate comprises a base and a coating layer formed of an UV curing material on the base.

7. The roll imprinting apparatus of claim 6, wherein the UV curing material is formed of one of a photoresist, a resin, and ink

8. The roll imprinting apparatus of claim 1, wherein the cylinder is formed of quartz, glass, or transparent plastic.

9. The roll imprinting apparatus of claim 8, wherein the pattern of the cylinder is formed through electron beam lithography, photo lithography, and laser irradiation.
